(19) United States
(12) Patent Application Publication
(10) Pub. No.: US 2025/0047112 A1
(43) Pub. Date: Feb. 6, 2025

(54) METHOD FOR CHARGING A BATTERY, BATTERY AND USE OF SUCH A BATTERY

(71) Applicant: Robert Bosch GmbH, Stuttgart (DE)

(72) Inventors: Stefan Teusch, Reutlingen (DE); Daniel Groezinger, Stuttgart (DE); Joachim Joos, Gerlingen (DE)

(21) Appl. No.: 18/719,824

(22) PCT Filed: Dec. 19, 2022
(86) PCT No.: PCT/EP2022/086536

§ 371 Date: Jun. 13, 2024

(30) Foreign Application Priority Data
Dec. 17, 2021 (DE) 10 2021 214 574.4

(51) Int. Cl. H02J 7/00

(52) U.S. Cl. CPC H02J 7/0025; H02J 7/0014

(57) ABSTRACT

The invention relates to a method for charging a battery (10) having a plurality of battery cells (101, 102, 103, 104), the plurality of battery cells (101, 102, 103, 104) being electrically interconnected in series. The respective charging process of at least two battery cells (101, 102) is started at different times.

### BACKGROUND

The present invention relates to a method for charging a battery, battery, and use of such a battery.

To implement electric mobility, rechargeable batteries are used for the multiple conversion of chemical energy into electrical energy. Lithium-ion batteries are particularly suitable for this due to their comparatively high energy density, good thermal stability, and low self-discharge.

A DC voltage is usually used to charge such lithium-ion batteries, which is supplied via rectifiers. This results in electrical losses in the rectifiers. Furthermore, the rectifiers also entail higher manufacturing costs.

A charging method for a battery using an electronic circuit comprising a rectifier is known from JP 2001178013 A.

Furthermore, a charging device for a battery that is designed to generate a pulse width modulation signal is known from US 20190173304 A1.

### SUMMARY

A method for charging a battery with a plurality of battery cells having the characterizing features of the independent claims is disclosed.

In the method according to the invention, the respective charging process of at least two battery cells is started at different times. The multiple battery cells are electrically interconnected in series.

The series connection ensures that the same charging current flows through the multiple battery cells. The method according to the invention offers the advantage that the individual battery cells are charged independently of each other despite the series connection. This advantageously prevents overcharging of the relevant battery cells. Furthermore, the method according to the invention adapts the terminal voltage of the battery when a charging voltage is applied.

Further advantageous embodiments of the present invention are the subject matter of the dependent claims.

It is advantageous if the at least two battery cells are each designed with a drive circuit.

This measure offers the advantage that overcharging of the relevant battery cells is easily avoided. Similarly, the battery cells can be charged evenly, so that each battery cell receives an approximately equal charge level, regardless of the aging of the respective battery cell.

It is also advantageous if the at least one battery cell of the at least two battery cells is electrically interconnected in parallel with other battery cells.

Furthermore, it is advantageous if a bridge rectifier circuit between an AC voltage source and the battery is designed in such a way that the AC voltage from the AC voltage source is converted to a DC voltage as a charging voltage for the battery. The sign of the charging voltage remains unchanged during the charging process of the battery, while the value of the charging voltage is subject to a periodic change. Advantageously, the value is subject to a periodic continuous change.

In this way, the battery is charged with a DC voltage, which is converted from the AC voltage of the AC voltage source using a bridge rectifier circuit without further filters or converters such as DC/DC converters or inverters.

It is also advantageous if the bridge rectifier circuit is further switched off in such a way that the charging voltage only has a positive voltage value during the charging process.

As the battery in question can only be charged with a charging voltage of greater than 0 V, this ensures that the battery is charged continuously throughout the entire charging process.

Furthermore, it is advantageous if the at least two battery cells are switched on or off one after the other by means of the respective drive circuit depending on the charging voltage.

It is particularly advantageous if the number of battery cells switched on by means of the respective drive circuit is increased with the increase in the charging voltage value and reduced with the decrease in the charging voltage value.

Increasing the number of battery cells switched on or reducing the number of battery cells switched on increases or reduces the terminal voltage of the battery, as this terminal voltage is formed by the sum of the individual battery cell voltages. Each battery cell voltage has a predetermined voltage value, for example, so that the terminal voltage has an incremental curve with the increase in the number of battery cells switched on and an opposite incremental curve with the reduction in the number of battery cells switched on. In this way, a difference between the charging voltage and the terminal voltage is kept approximately constant.

It is also advantageous if the switch-on time of the individual battery cell is regulated by means of the respective drive circuit depending on the charging voltage value.

If a battery cell is switched on for longer, its battery cell voltage increases. In this way, the curve of the terminal voltage is modeled on the curve of the charging voltage.

It is also advantageous if the number of battery cells switched on is regulated in such a way that a constant direct current flows through the battery. Alternatively or additionally, the switch-on time of the switched-on battery cells is regulated in such a way that a constant direct current flows through the battery.

This measure offers the advantage that the battery can be charged directly with a half-wave of the AC voltage without a rectifier.

It is particularly advantageous if the charging voltage value is increased by means of an electrical energy store when the charging voltage value is below a predetermined minimum value, so that the constant direct current flows through the battery at all times during the charging process. The electrical energy store can be a storage capacitor, for example.

As no charging current can flow through the battery at the zero points of the charging voltage, a slight increase in the charging voltage is achieved by means of the electrical energy store. As a result, a constant direct current flows through the battery even at the low points of the charging voltage. This, in turn, means that no interference filters are required, as constant currents do not induce alternating magnetic fields and therefore interference wave radiation is minimized.

According to a further aspect of the present invention, a battery comprising a plurality of battery cells which are electrically interconnected in series is provided. At least one drive circuit for carrying out the disclosed method is provided.

Thus, it is advantageous if an electrical energy store for carrying out the disclosed method is additionally provided.

It is also advantageous if the number of multiple battery cells is determined in such a way that the terminal voltage difference is compensated in the event of the failure of at least one battery cell.

The battery according to the invention can be advantageously used in electric vehicles or in the stationary storage of electrical energy as well as in e-bikes.

### BRIEF DESCRIPTION OF THE DRAWINGS

Advantageous embodiments of the present invention are illustrated in the drawing and further explained in the following description of the figures. The figures show:

FIG. 1a a circuit diagram of a battery at a first time of a method for charging the battery according to the present invention,

FIG. 1b a circuit diagram of a battery at a second time of a method for charging the battery according to the present invention,

FIG. 2 circuit diagram of a battery management system for performing a method of charging a battery according to the present invention, and

FIG. 3a-3e, exemplary voltage curves over the charging process of a battery.

### DETAILED DESCRIPTION

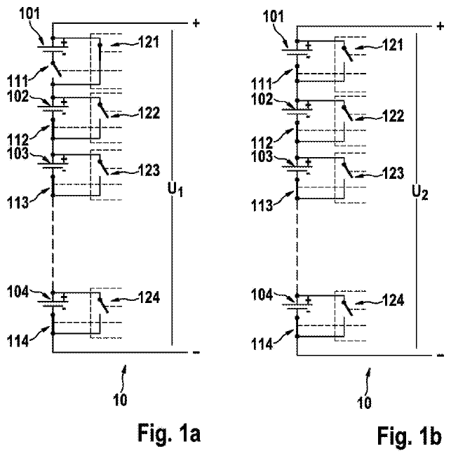

FIG. 1a shows a circuit diagram of a battery 10 during a first time of a method for charging the battery 10 according to the present invention. The battery 10 comprises, for example, a first battery cell 101, a second battery cell 102, a third battery cell 103, and a fourth battery cell 104. Any number of battery cells can be interconnected, depending on the terminal voltage to be achieved for the battery 10. Advantageously, more battery cells are interconnected than are required to achieve the terminal voltage of the battery. This means that if a battery cell fails, the missing terminal voltage difference of the battery 10 can be compensated for. For example, the first battery cell 101 is electrically interconnected in series with a first electrical switch 111 and in parallel with a second electrical switch 121. Analogously to the first battery cell 102, the second battery cell 102 is electrically interconnected in series, for example with a third electrical switch 112 and in parallel with a fourth electrical switch 122, the third battery cell 103 is electrically interconnected in series, for example with a fifth electrical switch 113 and in parallel with a sixth electrical switch 123, and the fourth battery cell 104 is electrically interconnected in series, for example with a seventh electrical switch 114 and in parallel with an eighth electrical switch 124.

During the first time, for example, the first electrical switch 111 is switched off, while the second electrical switch 121 is switched on. Thus, a charging current flows through the second electrical switch 121 to the second battery cell 102 instead of through the first battery cell 101. In contrast, the charging current flows through the second, third, and fourth battery cells 102, 103, 104 when the third, fifth, and seventh electrical switches 112, 113, 114 are switched on. At the same time, the fourth, sixth, and eighth electrical switches 122, 123, 124 are switched off.

The terminal voltage U₁ of the battery 10, at the first time, is formed by the sum of the voltages at the second electrical switch 121, at the second battery cell 102, at the third battery cell 103, and at the fourth battery cell 104.

FIG. 1b shows a circuit diagram of a battery 10 at a second time of a method for charging the battery 10 according to the present invention. The same reference numerals denote the same components as in FIG. 1a.

The second time occurs after the first time, for example. The charging voltage value at the second time is greater than the charging voltage value at the first time. The battery 10 according to FIG. 1b differs from the battery 10 according to FIG. 1a in that the second electrical switch 121 is switched off, while the first electrical switch 111 is switched on. This results in a charging current flowing through the first battery cell 101 to the second battery cell 102. The terminal voltage U₂ of the battery 10 at the second time results from the voltages at the first battery cell 101, at the second battery cell 102, at the third battery cell 103, and at the fourth battery cell 104. For example, the value of the terminal voltage U₂ of the battery 10 at the second time is greater than the value of the terminal voltage U₁ of the battery 10 at the first time. The reason for this is that the first battery cell 101 has a greater resistance than the second electrical switch 121. As a result, the first battery cell 101 is charged at the second time and the charging current is reduced. The difference between the voltage value of the half-wave of the charging voltage and the terminal voltage U₂ of the battery 10 is thus reduced by the terminal voltage of the first battery cell 101.

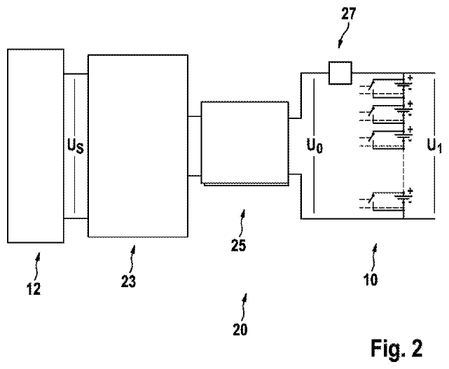

FIG. 2 shows a schematic circuit diagram of a battery management system 20 with a battery 10 as shown in FIGS. 1a and 1b. The same reference numerals denote the same components as in FIGS. 1a and 1b.

The battery management system 20 is electrically coupled to an AC voltage source 12 via a connection unit 23, for example. The connection unit 23 is, for example, a charging cable for an electric vehicle. For example, an AC voltage Uₛ is taken from the AC voltage source 12, which is converted to a DC voltage U₀ by means of a bridge rectifier circuit 25 of the battery management system 20. UₛU₀ For example, a storage capacitor is interconnected in parallel with the bridge rectifier circuit 25 as a component of the battery management system 20, which is used, for example, to supply the battery 10 with an electrical voltage when the DC voltage U₀ has zero points. U₀ The battery management system 20 further comprises an electrical switch 27, which is used, for example, to electrically disconnect the battery 10 from the AC voltage source 12 when the individual battery cells of the battery 10 are fully charged or the battery is to be used to supply power to a load.

The battery management system 20 can, for example, be extended by a further battery that comprises several battery cells and is designed in such a way that the negative half-wave of the AC voltage flows through the several battery cells so that no bridge rectifier circuit and no storage capacitor are required. Uₛ

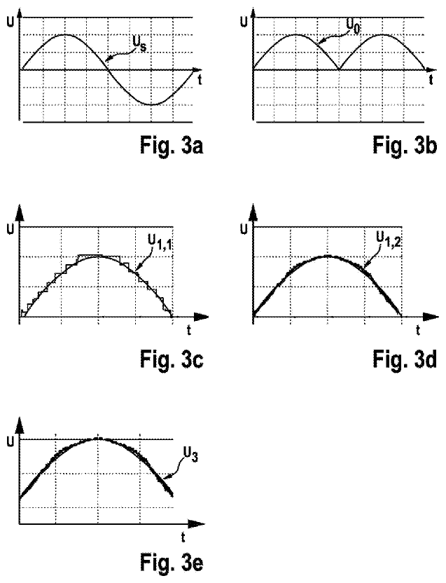

FIG. 3a shows an exemplary diagram of an AC voltage curve over the charging process of a battery 10 as shown in FIGS. 1a and 1b.

The AC voltage Uₛ from a transformer, for example, has a sinusoidal curve. The first half of the sinusoidal curve has positive voltage values, while the second half of the sinusoidal curve has negative voltage values.

FIG. 3b shows an exemplary diagram of a first DC voltage curve over the charging process of a battery 10 as shown in FIGS. 1a and 1b.

The DC voltage curve shown in FIG. 3b differs from the AC voltage curve shown in FIG. 3a in that the sign of the DC voltage U₀ remains unchanged during the charging process of the battery 10.

FIG. 3c shows an exemplary diagram of a first terminal voltage curve over the charging process of a battery 10 as shown in FIGS. 1a and 1b.

According to FIG. 3c, the terminal voltage U_{1,1} of the battery 10 has a stepped curve. If the number of battery cells 101, 102, 103, 104 of the battery 10 to be connected or disconnected is controlled with regard to the increase or reduction of the charging voltage values, the step-shaped curve of the terminal voltage as shown in FIG. 3c is produced, since the terminal voltage of the battery 10 is increased by increasing the number of battery cells connected, this terminal voltage being formed by the sum of individual battery cell voltages. U_{1,1}U_{1,1}U_{1,1} Each battery cell voltage has a predetermined voltage value, for example, so that the terminal voltage has a stepped curve as the number of connected battery cells increases. U_{1,1} Accordingly, the terminal voltage U_{1,1} exhibits an opposite, further step-like curve when the number of connected battery cells is reduced.

FIG. 3d shows an exemplary diagram of a second terminal voltage curve over the charging process of a battery 10 as shown in FIGS. 1a and 1b.

In addition to FIG. 3c, the switch-on time of the battery cells 101, 102, 103, 104 to be connected is controlled with regard to, for example, the increase in the charging voltage values, so that the terminal voltage of the battery 10 has a sinusoidal curve like a DC voltage. U_{1,2} The terminal voltage value of the battery 10 is, for example, lower than the charging voltage value at all times during the charging process of the battery 10. Furthermore, the difference between the charging voltage value and the terminal voltage value of the battery 10 is constant at all times during the charging process of the battery 10, for example.

FIG. 3e shows an exemplary diagram of a second DC voltage curve over the charging process of a battery 10 as shown in FIGS. 1a and 1b.

The second DC voltage curve in FIG. 3e differs from the first DC voltage curve in FIG. 3b in that the second DC voltage has no zeros. U₃ Because the second DC voltage U₃ as the charging voltage has no zeros, a charging current flows through the battery 10 over the entire charging process of the battery 10. This is particularly advantageous if the battery 10 is supplied with electricity from an off-grid source such as a natural gas generator.

The battery 10 can be used advantageously in motor vehicles or in stationary storage of electrical energy as well as in e-bikes.

1. A method for charging a battery (10) having a plurality of battery cells (101, 102, 103, 104),
wherein the plurality of battery cells (101, 102, 103, 104) are electrically interconnected in series,
wherein
the respective charging process of at least two battery cells (101, 102) is started at different times.

2. The method according to claim 1,
wherein
the at least two battery cells (101, 102) are each designed with a drive circuit (111, 121, 112, 122).

3. The method according to claim 1,
wherein
the at least one battery cell of the at least two battery cells (101, 102) is electrically interconnected in parallel with other battery cells.

4. The method according to claim 1,
wherein
a bridge rectifier circuit (25) between an AC voltage source (12) and the battery (10) is designed in such a way that the AC voltage (Uₛ) from the AC voltage source (12) is converted into a DC voltage (U₀) as charging voltage for the battery (10), the sign of which remains unchanged during the charging process of the battery (10), while its value is subject to a periodic change.

5. The method according to claim 4,
wherein
the bridge rectifier circuit (25) is further switched off in such a way that the charging voltage only has a positive voltage value during the charging process. (U₃)

6. The method according to claim 1,
wherein
the at least two battery cells (101, 102) are switched on or off one after the other by means of the respective drive circuit (111, 121, 112, 122) depending on the charging voltage. (U₀, U₃)

7. The method according to claim 6,
wherein
the number of battery cells (101, 102, 103, 104) switched on by means of the respective drive circuit (111, 121, 112, 122, 113, 123, 114, 124) is increased with the increase in the charging voltage value and reduced with the decrease in the charging voltage value.

8. The method according to claim 6,
wherein
the switch-on time of the individual battery cell (101, 102, 103, 104) is controlled by means of the respective drive circuit (111, 121, 112, 122, 113, 123, 114, 124) as a function of the charging voltage value.

9. The method according to claim 6,
wherein
the number of battery cells (101, 102, 103, 104) switched on and/or the switch-on time are regulated in such a way that a constant direct current flows through the battery (10).

10. The method according to claim 4,
wherein
the charging voltage value is increased by means of an electrical energy store when the charging voltage value is below a predetermined minimum value, so that the constant direct current flows through the battery (10) at all times during the charging process.

11. A battery comprising a plurality of battery cells (101, 102, 103, 104), wherein the plurality of battery cells (101, 102, 103, 104) are electrically interconnected in series, and
at least one driving circuit (111, 121, 112, 122, 113, 123, 114, 124) that is configured to start charging processes of at least two battery cells (101, 102) at different times.

12. The battery according to claim 11, further comprising an electrical energy store.

13. The battery according to claim 11,
wherein
the number of multiple battery cells (101, 102, 103, 104) is determined in such a way that the terminal voltage difference is compensated in the event of the failure of at least one battery cell.

14. (canceled)
